(19) United States
(12) Patent Application Publication
(10) Pub. No.: US 2006/0089875 A1
(43) Pub. Date: Apr. 27, 2006

(54) Integrated online purchase reward system

(76) Inventors: Dae Song Park, Los Angeles, CA (US); Chang Hie Jung, Los Angeles, CA (US); Bo Hyouk Lee, Los Angeles, CA (US); Brian Chung, Los Angeles, CA (US)

Correspondence Address: PARK LAW FIRM, 3255 WILSHIRE BLVD, SUITE 1110, LOS ANGELES, CA, 90010, US

(21) Appl. No.: 10/970,934

(22) Filed: Oct. 22, 2004

(51) Int. Cl. G06Q 30/00

(52) U.S. Cl. 705/14

(57) ABSTRACT

An integrated online purchase reward system includes one or more first information processing devices, one or more second information processing devices, a network, and one or more purchase transaction monitoring devices which read in a purchase transaction medium, and print out purchase transaction records on the purchase transaction media as a hard copy. The first information processing devices receive, process, and distribute data, and respond to requests from the second information processing devices. The first information processing device includes database, and the second information processing devices are connected with the purchase transaction monitoring device. The network works on a TCP/IP Protocol environment and connects the first and the second information processing devices. The purchase transaction information including reward or gift is printed on a PET card through line thermal printing. A person with an appropriate authorization can access the first information processing device through internet and retrieve data.

### BACKGROUND OF THE INVENTION

This invention is related to an integrated online purchase reward system, which promotes business mainly by networking and visualizing the on-site and accumulating reward for the customers.

The modern society can be characterized as a complex super-network knitted from networks of buyers and sellers, or from networks of customers and producers of product or service.

In this jungle of networks, a large number of sellers or producers try to reach and sell their products or services to a much larger number of potential customers.

To promote the business, there are many traditional well-known methods; advertising, personal selling, sales promotion, publicity, etc. Especially, the sales promotion is related to increase consumer demand, stimulate market demand or improve product availability. The examples of sales promotion include coupons, disounts sales, contests, point of purhcase displays, and rebates.

In spite of all the traditional marketing methods, it is still challenging to all businesspersons to keep the first-time customers for the next potential purchases in near and far future. Basically, there are too many competitors in the market.

Therefore, the business will be quite successful if the sellers can help the customers to remember the sellers and, furthermore, to be motivated to purchase from the given sellers.

From the point of view of sellers or producers, the buyer-seller networks are the physical pipes through which the products and services flow and the invisible pipes through which the marketing information flows, connecting the nodes; buyers and sellers. Usually, the marketing information flowing through the buyer-seller networks contains alphanumerical information on seller, customer, purchase, and the like.

Since it contains a lot of valuable information on the customers and the sellers, the marketing information flowing through the networks must be able to be used to promote the sales. If it is networked and organized electronically, the marketing information will be much more valuable. Especially in the highly networked modern society full of franchising, the marketing power of the networked and organized marketing information will be amplified tremendously if combined with some traditional marketing methods.

The sales promotion targeted at the consumer will be most effective if the rewarding of purchase is personalized, networked, visualized, and flexible.

Accordingly, a need for an integrated online purchase reward system to promote sales has been present for quite a long time through the long history of commerce. This invention is directed to solve these problems and satisfy the long-felt need.

### SUMMARY OF THE INVENTION

The present invention contrives to promote sales in businesses including the franchises.

An object of the invention is to provide a system visualizing the purchase reward information in a hard copy to help the customers to check the status of their prize points.

Another object of the invention is to provide a system networking the marketing information on sellers and buyers to promote the sales.

Still other object of the invention is to provide an integrated online purchase reward system networking the sellers and the buyers over the internet.

Still other object of the invention is to provide an integrated online purchase reward system that simplifies the procedure of issuing for new cards and that has more flexibility in handling the information printing on a card medium.

The integrated online purchase reward system include one or more first information processing devices, one or more second information processing devices, a network interconnecting the first information processing devices and the second information processing devices, and one or more purchase transaction monitoring devices which read in a purchase transaction medium, and print out purchase transaction records on the purchase transaction media as a hard copy. The first information processing devices receive, process, and distribute data, and respond to requests from the second information processing device.

The first information processing device working as a server includes database to store the purchase transaction information. The second information processing device is connected with the purchase transaction monitoring device working as terminal and includes a local device to store at least part of local purchase transaction records.

The purchase transaction monitoring device prints out the reward information on the purchase transaction medium according to the amount of purchase of customers.

The first information processing devices communicates electronically with the second information processing devices through the network, which works on a TCP/IP Protocol environment.

The purchase transaction monitoring device can be combined with the second information processing device into one. In that case, each purchase transaction monitoring device communicates directly with the first information processing device.

A predetermined person with a proper authorization can access the first information processing device, preferably from home, through the internet and retrieve data.

The purchase transaction information including reward and gift is printed on the card, preferably made of PET (polyethylene terephthalate), by line thermal printing.

Each of the purchase transaction monitoring devices includes one or more user interface devices with one or more input devices and one or more output devices. The input device includes a keypad device, and the output device includes a display and a printer, preferably an LCD display and a line thermal printer.

The user interface device takes alphanumerical information on seller, customer, and purchase from the outside world, and provides output including alphanumerical information on sales policy from the first information processing devices to the outside world. The user interface device takes in a PET card for reading and writing of information.

The integrated online purchase reward system includes the modules for purchase-rewarding, redeeming, refunding, and issuing of new card, bonus card, prepaid card, and cashier card. All functions are executed by punching the combination of keys from the keypad device.

The purchase-rewarding module performs recognizing a customer with account purchasing at a store with one of the terminals by reading the customer's card, calculating a purchase-rewarding point based on the purchase and a predetermined rewarding rate, updating the related information for the customer in the first information processing device, and printing the newly earned points on the customer's card.

The redeeming module performs recognizing a customer with account redeeming at a store with one of the terminals by reading the customer's card, updating the related information for the customer in the first information processing devices, and printing the subtraction of the redeemed points from the account on the customer's card.

The refunding module performs recognizing a customer with account refunding at a store with one of the terminals by reading the customer's card, updating the related information for the customer in the first information processing devices, and printing the subtraction of the refunded points from the account and the remaining points on the customer's card.

The first issuing module for issuing new card performs creating an account for a new customer purchasing at a store with one of the terminals, calculating a purchase-rewarding point based on the purchase and a predetermined rewarding rate, updating the related information for the customer in the first information processing devices, and printing the newly earned points on a new card. Compared to prior arts, the invention simplifies the procedure such that the two steps of issuing a new card and printing the newly earned points on the new card are done without ejecting the card.

The second issuing module for issuing bonus card or prepaid card performs creating an account for a customer purchasing the bonus or prepaid card at a store with one of the terminals, updating the related information for the customer in the first information processing devices, and printing a predetermined points on a new card.

The third issuing module for issuing cashier card performs creating an account for a cashier working at a store, updating the related information for the cashier in the first information processing devices, and printing a predetermined points on a new card.

More specifically, the purchase transaction monitoring device includes a network interface, a keypad, a display, a card accepting device, a card reader, and a card printer. The first information processing device communicates a set of alphanumerical information on seller, cashier, customer, purchase, and internal commands through the internet. Since all the information is stored in the first information processing devices, there is no need for the individual second information processing devices to store the information locally.

A plurality of purchase transaction monitoring devices in a store are connected with a local computer. In an embodiment, it is connected with up to about 8 purchase transaction monitoring devices.

The purchase transaction monitoring device is connected to the second information processing device through RS-232C or RJ-45. The first information processing device is connected with up to about 9,999 second information processing devices.

The card, purchase transaction medium, is made of plastic material, preferably PET (polyethylene terephthalate).

The first information processing device is an SQL server.

Many other innovations, features, and advantages will be evident with the following description of the invention.

### BRIEF DESCRIPTION OF THE DRAWINGS

These and other features, aspects and advantages of the present invention will become better understood with reference to the accompanying drawings, wherein:

FIG. 1 is a schematic diagram of an integrated online purchase reward system;

FIG. 2 is a schematic diagram of an implementation of the integrated online purchase reward system;

FIG. 3 is a diagram of an interface between a second information processing device and a purchase transaction monitoring device;

FIG. 4 is a detailed diagram of the interface in FIG. 3;

FIG. 5 is a schematic diagram of the purchase transaction monitoring device;

FIG. 6 is a flow chart of a purchase reward transaction;

FIG. 7 is a hind view of the purchase transaction monitoring device;

FIG. 8 is a flow chart of the reimbursement;

FIG. 9 is a flow chart of a new bonus card issuing module with two time insertion of card; and

FIG. 10 is a flow chart of a new bonus card issuing module with one time insertion of card.

### DETAILED DESCRIPTION OF THE INVENTION

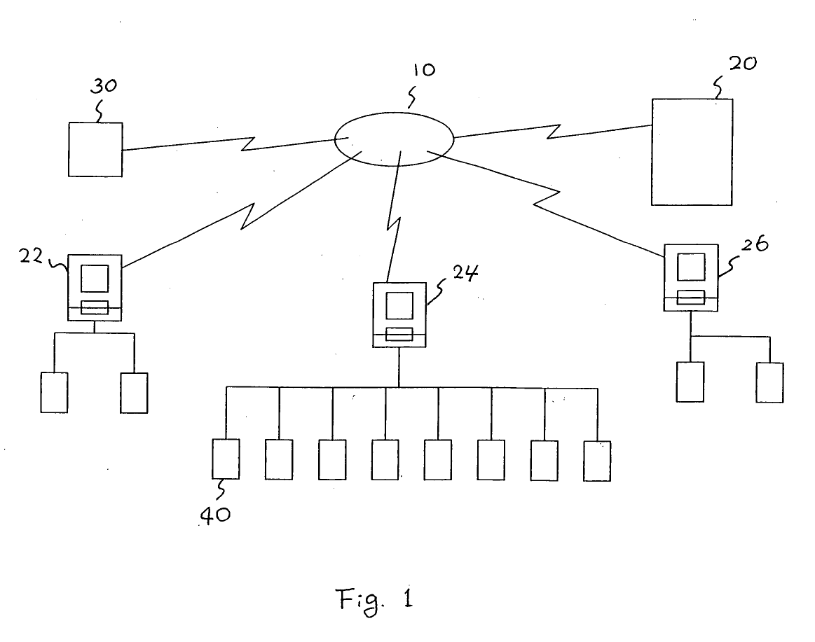

As shown in FIG. 1, an integrated online purchase reward system consists mainly of a server part 20, a terminal part 40, and a network 10. The server part 20 performs to maintain all the marketing information using database system and other control programs. The terminal part 40 communicates directly with the customers or their agents (store cashier) in handling the input and output information using user interfaces such as keypad device, LCD display, and card reader/printer. The network 10 interconnects the server, a first information processing device, 20 and one or more terminals, purchase transaction monitoring device, 40 which are usually far apart from one another physically. Sometimes, a small group of terminals 40 can be connected first to a local computer, a second information processing device, 24 and then to the server 20 through the local computer 24 or router, rather than reaching the server directly. In other situation, the purchase transaction monitoring device can be combined with the second information processing device into one.

More specifically, the integrated online purchase reward system include one or more first information processing devices 20, one or more second information processing devices 24, a network 10 interconnecting the first information processing devices 20 and the second information processing devices 24, and one or more purchase transaction monitoring devices 40 which read in a purchase transaction medium, and print out purchase transaction records on the purchase transaction media as a hard copy. The first information processing devices 20 receive, process, and distribute data, and respond to requests from the second information processing device 24.

The first information processing device 20 working as a server includes database to store the purchase transaction information. The second information processing device 24 is connected with the purchase transaction monitoring device 40 working as terminal and includes a local device to store at least part of local purchase transaction records. The local storing device can be used, for instance, as a temporary data reservoir to facilitate the transactions in a challenging networking situation such as failure of server 20, network 10, or power.

The purchase transaction monitoring device 40 prints out the reward information on the purchase transaction medium, which is calculated according to the amount of purchase of customers based on a given sales policy.

The first information processing devices 20 communicate electronically with the second information processing devices 24 through the network 10, which works preferably on a TCP/IP Protocol environment.

A predetermined person with a proper authorization can access the first information processing device 20, preferably from a home computer 30, through the internet and retrieve data. If the predetermined person is an owner of a store in a big franchise, for example, the owner will be very happy to check all the transactions occurring in her or his store in real time, sitting in front of home computer 30 in his cozy living room. The predetermined person can request the server 10 to extract or manipulate the raw data to accommodate the desired format such as sales amount for each store, each cashier, or each terminal.

The authorized person like a business owner at home or office can access the server and check lots of kinds of information including the sales amount, number of issued card, etc. for each of branch stores for the time period of day, week, month, or year. A customer can be also allowed to access the server with a restricted authority to check her or his reward points.

The purchase transaction information including reward and gift is printed on the card, preferably made of PET (polyethylene terephthalate) by line thermal printing.

This hard copy of reward points or gift from the sellers on a card is very important. Comparing with the traditional reward point card without any meaningful record about the reward point, this kind of reward point card showing their own points all the time is very effective to make the point card holder to be reminded of the business which issued the card and then to prompt to visit the store again in near future. The customer usually sticks all kinds of cards in her or his wallet and take out the wallet at least several times a day. Then, most probably, the dumb point cards will be lost in the wallet and trashed away very soon, while the card, showing the stored points in hard copy every time when rummaging the wallet, keeps urging the customer to do something with the valuable points.

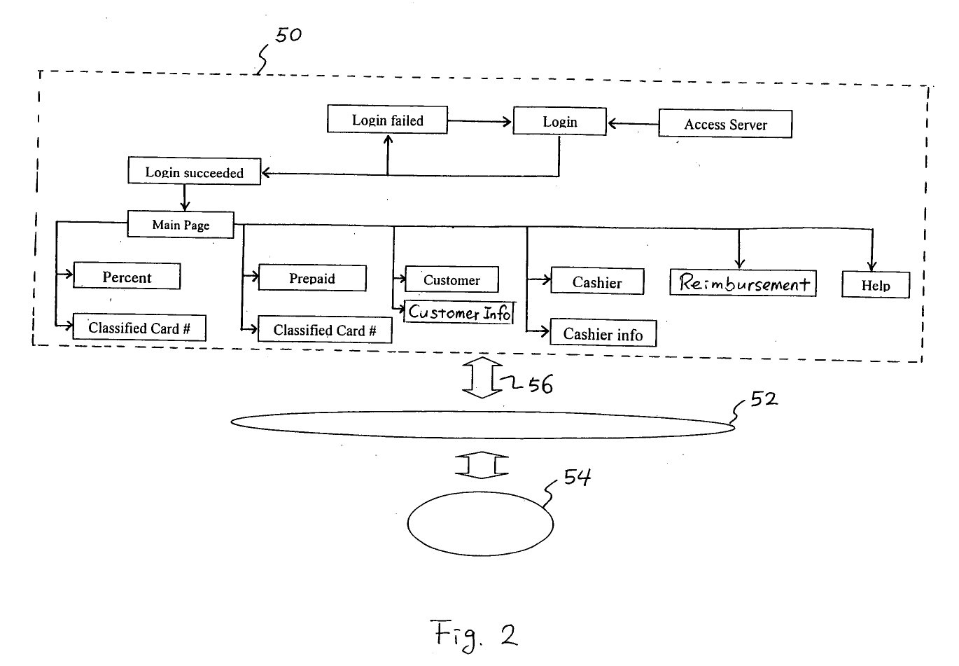

FIG. 2 shows an schematic application flow of an implementation of the integrated online purchase reward system using a Visual Basic .net 50. The Visual Basic net 50 is connected with a .net Framework 52 and a server 54, preferably an SQL server.

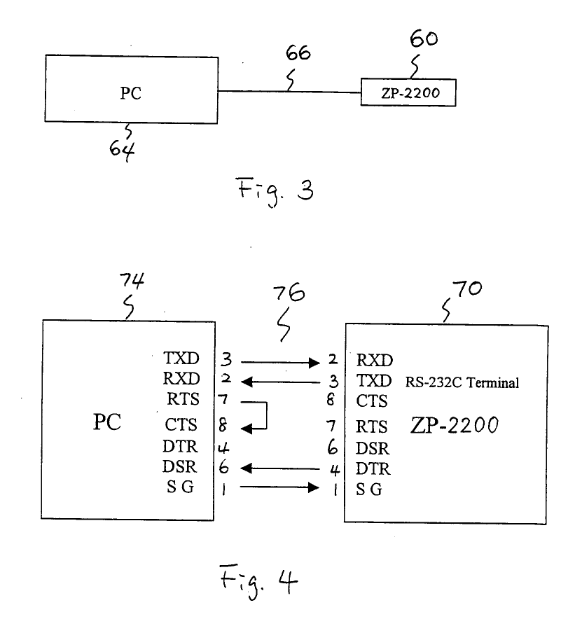

FIG. 3 shows the interface between the second information processing device 24 and the purchase transaction monitoring device 40 in FIG. 1. The purchase transaction monitoring device 60 is connected with the second information processing device 64 through an interface 66.

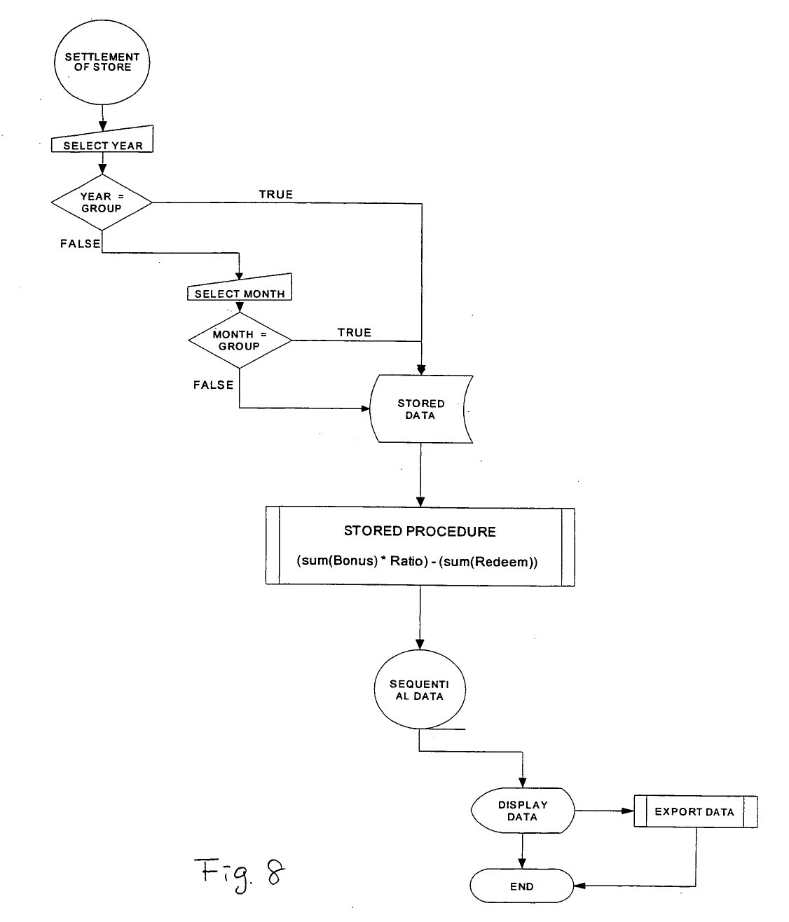

FIG. 4 shows the detailed interface in FIG. 3. The purchase transaction monitoring device 70 is connected with the second information processing device 74 through an interface 76, preferably RS-232C 82 or RJ-45 84 (FIG. 7), in which the pin connections are also shown.

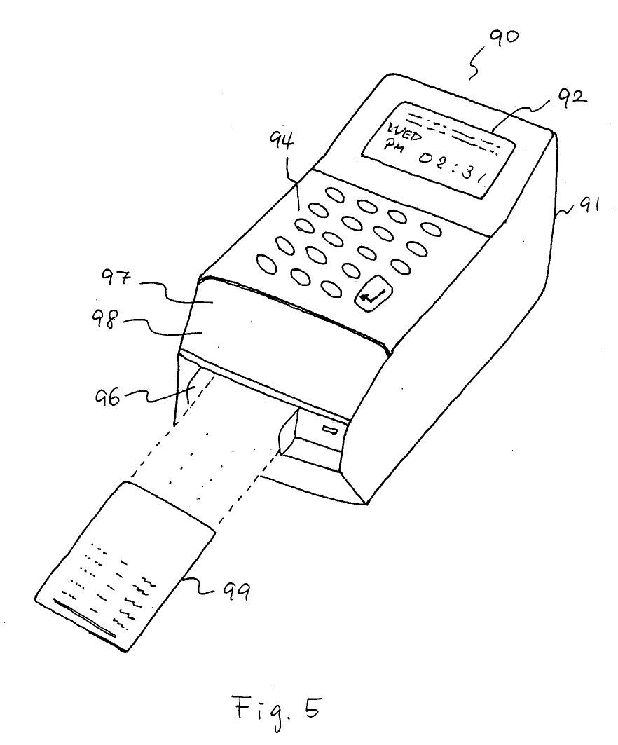

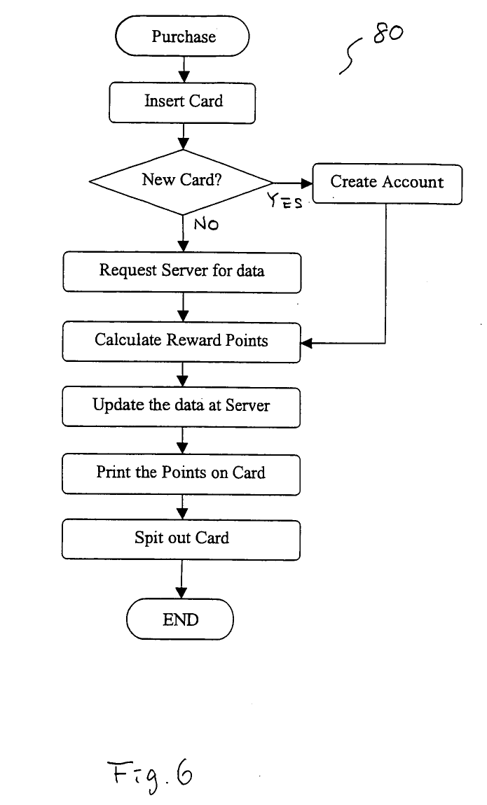

Each of the purchase transaction monitoring devices 90 shown in FIG. 5 includes one or more user interface devices with one or more input devices and one or more output devices. The input device includes a keypad device 94, and the output device includes a display and a printer, preferably an LCD display 92 and a line thermal printer 98.

The user interface device takes alphanumerical information on seller, customer, and purchase from the outside world, and provides output including alphanumerical information on sales policy from the first information processing devices to the outside world. The user interface device takes in a PET card 99 for reading and writing of information.

In other embodiment, the integrated online purchase reward system is adapted to a worldwide franchise of stores.

It cannot be overemphasizing to say that, in the modern commercial world, the franchise is one of the major phenomenal trends. The franchise model is almost in every business fields from fast food business to rent-a-car business.

The purchase reward system is much more effective with a networked business like franchise store. Therefore, the invention is a purchase reward system networked overcoming the temporal and spatial restriction, that is, an integrated “online” purchase reward system.

In that embodiment, the server includes an SQL server with a CPU, a database, and a memory. The SQL server manages a plurality of kinds of information of a plurality of customers from all the terminals in the network using a centralized database. The server can be accessed securely by a personal computer accessing the internet to check the transactions all over the terminals in the plurality of stores in real time.

The integrated online purchase reward system includes the functions for a purchase rewarding module, a redeeming module, a refunding module, a first issuing module for issuing new card, a second issuing module for issuing module for issuing bonus card and prepaid card, and a third issuing module for issuing cashier card. All functions are executed by punching the combination of keys from the keypad device.

The purchase-rewarding module performs recognizing a customer with account purchasing at a store with one of the terminals by reading the customer's card, calculating a purchase-rewarding point based on the purchase and a predetermined rewarding rate, updating the related information for the customer in the first information processing device, and printing the newly earned points on the customer's card.

The redeeming module performs recognizing a customer with account redeeming at a store with one of the terminals by reading the customer's card, updating the related information for the customer in the first information processing devices, and printing the subtraction of the redeemed points from the account on the customer's card.

The refunding module performs recognizing a customer with account refunding at a store with one of the terminals by reading the customer's card, updating the related information for the customer in the first information processing devices, and printing the subtraction of the refunded points from the account and the remaining points on the customer's card.

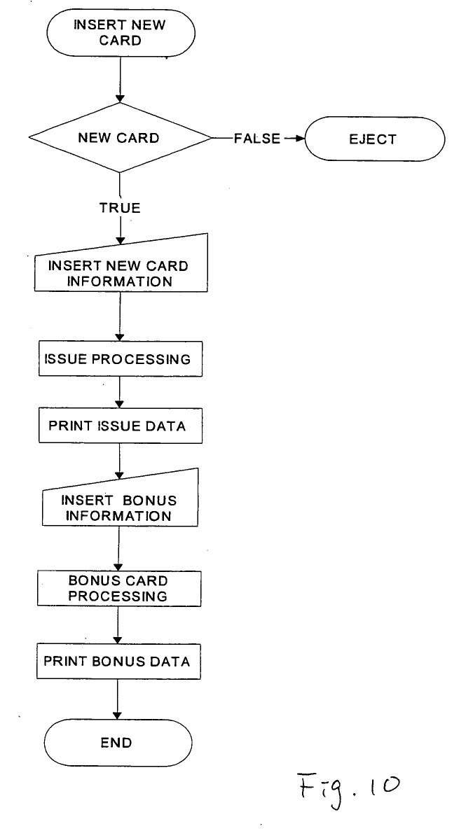

The first issuing module for issuing new card performs creating an account for a new customer purchasing at a store with one of the terminals, calculating a purchase-rewarding point based on the purchase and a predetermined rewarding rate, updating the related information for the customer in the first information processing devices, and printing the newly earned points on a new card. The invention simplifies the procedure such that the two steps of issuing a new card and printing the newly earned points on the new card are done without ejecting the card. In order to create a new card in commercially available prior arts, a new card had to be inserted to print a head title at the top of the card, spit out, and then be reinserted to print the newly earned points, referring to FIG. 9 and FIG. 10.

The second issuing module for issuing bonus card or prepaid card performs creating an account for a customer purchasing the bonus or prepaid card at a store with one of the terminals, updating the related information for the customer in the first information processing devices, and printing a predetermined points on a new card. Also, a head title including seller's name and advertising message can be printed along with the predetermined points.

The third issuing module for issuing cashier card performs creating an account for a cashier working at a store, updating the related information for the cashier in the first information processing devices, and printing a predetermined points on a new card. The cashier card is used by a cashier working at the store to identify herself or himself to the system.

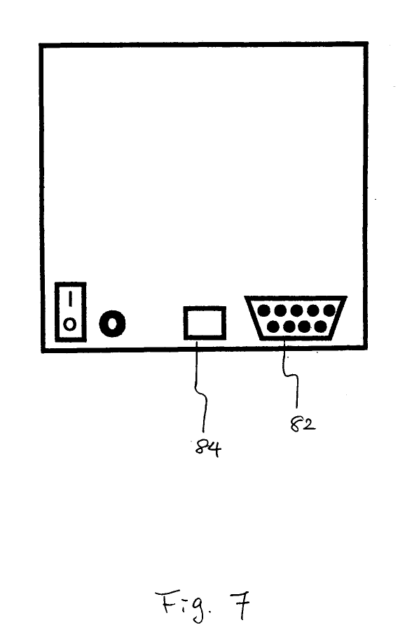

FIG. 6 shows a typical operation of the module 80 for purchase rewarding.

When a customer purchases a commodity in a store, the cashier checks if the customer is a member customer or not. If the customer is a member customer or card holder, then the card is inserted to the card reader, the purchase transaction monitoring device. Then the card reader communicates with, requests, and retrieves data from the server. If the customer is not a member, then a new card is issued by creating an account at the server.

After retrieving data on the customer with either old or new card, the reward point is calculated based on the purchase amount, the new reward point is added to the account, and the related information is updated at the server.

Then, the information including the newly earned reward point and the new total point is printed on the card by line thermal printing. And, the card reader spits out the card.

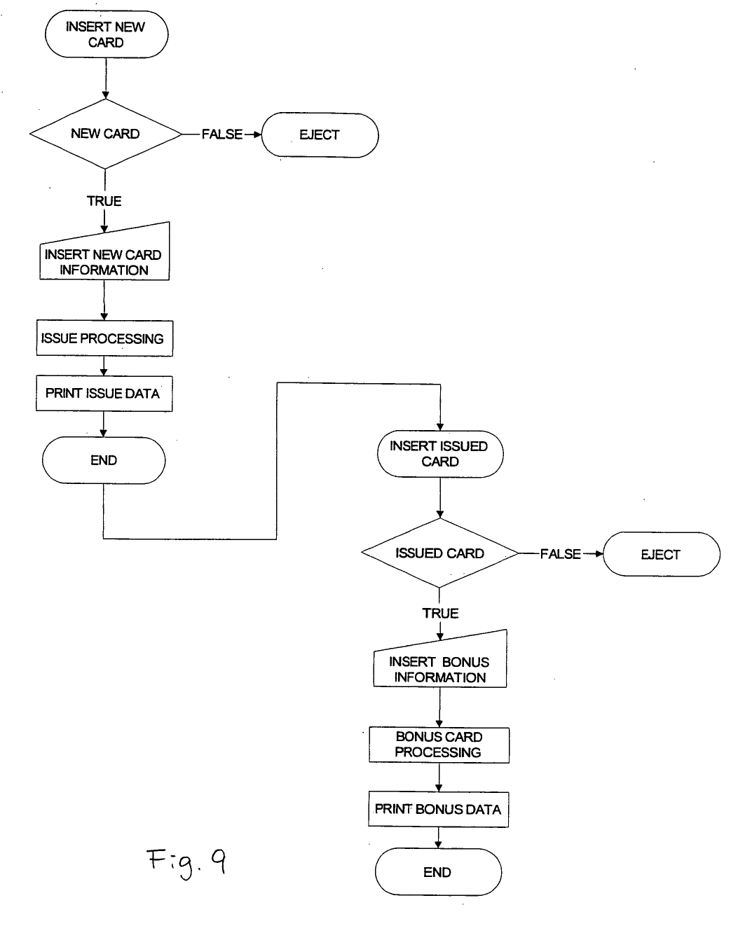

FIG. 8 shows another operation of the module 80 for a reimbursement.

In another embodiment, the purchase transaction monitoring device 90 includes a network interface 91, a keypad 94, a display 92, a card accepting device 96, a card reader 97, and a card printer 98 as shown in FIG. 5. The first information processing device 20 communicates a set of alphanumerical information on seller, customer, purchase, and internal commands through the internet. Since all the information is stored in the first information processing devices 20, there is no need for the individual second information processing devices 24 to store the information locally.

A plurality of the purchase transaction monitoring devices 40 in a store are connected with a local computer 24. In an embodiment, it is connected with up to about 8 purchase transaction monitoring devices 40 as shown in FIG. 1.

The purchase transaction monitoring device 40 is connected to the second information processing device, a local computer or a router, 24 through RS-232C 82 or RJ-45 84 (FIG. 7). The first information processing device 20 is connected with up to about 9,999 second information processing devices 24 through the network 10.

The card, purchase transaction medium, is made of plastic material, preferably PET (polyethylene terephthalate).

In still another embodiment, the integrated online purchase reward system includes one or more first information processing devices 20, one or more second information processing devices 24, one or more purchase transaction monitoring devices 90 which read in a purchase transaction medium 99, and print out purchase transaction records on the purchase transaction medium 99 as a hard copy, and a network interconnecting the first information processing devices 20, the second information processing devices 24, and the purchase transaction monitoring devices 90.

Also, in this embodiment, the first information processing devices 20 receive, process, and distribute data, and respond to requests from the second information processing devices 24 and the purchase transaction monitoring devices 90.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An integrated online purchase reward system comprising
a) one or more first information processing devices;
b) one or more second information processing devices;
c) a network interconnecting the first information processing devices and the second information processing devices; and
d) one or more purchase transaction monitoring devices which read in a purchase transaction medium, and print out purchase transaction records on the purchase transaction media as a hard copy,
wherein the first information processing devices receive, process, and distribute data, and respond to requests from the second information processing devices.

2. The integrated online purchase reward system according to claim 1, wherein the first information processing device comprises a database.

3. The integrated online purchase reward system according to claim 1, wherein the second information processing device is connected with the purchase transaction monitoring device.

4. The integrated online purchase reward system according to claim 3, wherein the second information processing device comprises a local device to store at least part of local purchase transaction records.

5. The integrated online purchase reward system according to claim 1, wherein the purchase transaction monitoring device prints out the reward information on the purchase transaction medium according to the amount of purchase of customers.

6. The integrated online purchase reward system according to claim 1, wherein the first information processing devices communicates electronically with the second information processing devices through the network.

7. The integrated online purchase reward system according to claim 6, wherein the network works on the TCP/IP Protocol environment.

8. The integrated online purchase reward system according to claim 7, wherein a person with a proper authorization can access through the internet and retrieve data from the first information processing device.

9. The integrated online purchase reward system according to 8, wherein the data comprises a set of alphanumerical information on seller, cashier, customer, and purchase process by the first information processing device.

10. The integrated online purchase reward system according to 1, wherein the second information processing device is combined with the purchase transaction monitoring device.

11. The integrated online purchase reward system according to 1, wherein the purchase transaction medium is a card, wherein the purchase transaction information including reward is printed on the card.

12. The integrated online purchase reward system according to claim 11, the printing is done with line thermal printing method.

13. The integrated online purchase reward system according to claim 1, each of the purchase transaction monitoring devices comprises one or more user interface devices.

14. The integrated online purchase reward system according to claim 13, wherein the user interface device comprises one or more input devices and one or more output devices.

15. The integrated online purchase reward system according to claim 14, wherein the input device comprises a keypad device.

16. The integrated online purchase reward system according to claim 14, wherein the output devices comprise a display and a printer.

17. The integrated online purchase reward system according to claim 16, wherein the printer is a thermal printing device.

18. The integrated online purchase reward system according to claim 13, wherein the user interface device takes information from the outside world.

19. The integrated online purchase reward system according to claim 18, wherein the information comprises alphanumerical information on seller, cashier, customer, and purchase.

20. The integrated online purchase reward system according to claim 13, wherein the user interface device provides output from the first information processing devices to the outside world.

21. The integrated online purchase reward system according to claim 20, wherein the output from the first information processing devices comprises alphanumerical information.

22. The integrated online purchase reward system according to claim 13, wherein the user interface device takes in the purchase transaction medium for reading and writing of information.

23. The integrated online purchase reward system according to claim 22, wherein the system comprises a purchase-rewarding module, a redeeming module, and a refunding module.

24. The integrated online purchase reward system according to claim 23, wherein the functions are executed by punching the combination of keys from the keypad device.

25. The integrated online purchase reward system according to claim 22, wherein the system further comprises a first issuing module for issuing a new card, a second issuing module for issuing a bonus card and a prepaid card, and a third issuing module for issuing a cashier card.

26. The integrated online purchase reward system according to claim 25, wherein the functions are executed by punching the combination of keys from the keypad device.

27. The integrated online purchase reward system according to claim 1, wherein the system comprises a purchase-rewarding module, a redeeming module, and a refunding module.

28. The integrated online purchase reward system according to claim 27, wherein the purchase-rewarding module performs;
a) recognizing a customer with account purchasing at a store with one of the terminals by reading the customer's card;
b) calculating a purchase-rewarding point based on the purchase and a predetermined rewarding rate;
c) updating the related information for the customer in the first information processing device; and
d) printing the newly earned points on the customer's card.

29. The integrated online purchase reward system according to claim 27, wherein the redeeming module performs;
a) recognizing a customer with account redeeming at a store with one of the terminals by reading the customer's card;
b) updating the related information for the customer in the first information processing devices; and
c) printing the subtraction of the redeemed points from the account on the customer's card.

30. The integrated online purchase reward system according to claim 27, wherein the refunding module performs;
a) recognizing a customer with account refunding at a store with one of the terminals by reading the customer's card;
b) updating the related information for the customer in the first information processing devices; and
c) printing the subtraction of the refunded points from the account and the remaining points on the customer's card.

31. The integrated online purchase reward system according to claim 1, wherein the system comprises a purchase-rewarding module, a redeeming module, a refunding module, a first issuing module for issuing a new card, a second issuing module for issuing a bonus card and a prepaid card, and a third issuing module for issuing a cashier card.

32. The integrated online purchase reward system according to claim 31, wherein the first issuing module of new card performs;
a) creating an account for a new customer purchasing at a store with one of the terminals;
b) calculating a purchase-rewarding point based on the purchase and a predetermined rewarding rate;
c) updating the related information for the customer in the first information processing devices; and
d) printing the information about the seller and customer and the newly earned points on a new card.

33. The integrated online purchase reward system according to claim 31, wherein the second issuing module of bonus card or prepaid card performs;
a) creating an account for a customer purchasing the bonus or prepaid card at a store with one of the terminals;
b) updating the related information for the customer in the first information processing devices; and
c) printing the seller information, a marketing information, and a predetermined points on a new card.

34. The integrated online purchase reward system according to claim 31, wherein the third issuing module of cashier card performs;
a) creating an account for a cashier working at a store;
b) updating the related information for the cashier in the first information processing devices; and
c) printing a predetermined points on a new card.

35. The integrated online purchase reward system according to claim 1, the purchase transaction monitoring device comprises a network interface, a keypad, a display, a card accepting device, a card reader, and a card printer.

36. The integrated online purchase reward system according to claim 35, wherein the first information processing device communicates a set of alphanumerical information on seller, customer, purchase, and internal commands through the internet.

37. The integrated online purchase reward system according to claim 36, wherein all the information is stored in the first information processing devices.

38. The integrated online purchase reward system according to claim 35, wherein a plurality of purchase transaction monitoring devices in a store are connected with a local computer.

39. The integrated online purchase reward system according to claim 38, wherein the local computer is connected with up to about eight (8) purchase transaction monitoring devices.

40. The integrated online purchase reward system according to claim 38, wherein the purchase transaction monitoring device is connected to the second information processing device through RS-232C or RJ-45.

41. The integrated online purchase reward system according to claim 38, wherein the local computer is connected with the first information processing devices through the internet using TCP/IP protocol.

42. The integrated online purchase reward system according to claim 38, wherein the first information processing device is connected with up to about nine thousand nine hundred ninety nine (9,999) local computers.

43. The integrated online purchase reward system according to claim 35, wherein the display is a LCD display.

44. The integrated online purchase reward system according to claim 35, wherein the printer is a line thermal printer.

45. The integrated online purchase reward system according to claim 35, wherein the card is made of plastic material.

46. The integrated online purchase reward system according to claim 45, wherein the plastic material is PET (polyethylene terephthalate).

47. The integrated online purchase reward system according to claim 35, wherein the first information processing device is an SQL server.
